(19) United States
(12) Patent Application Publication
(10) Pub. No.: US 2026/0011163 A1
(43) Pub. Date: Jan. 8, 2026

(54) INFORMATION PROCESSING APPARATUS, ANALYSIS METHOD, AND NON-TRANSITORY COMPUTER-READABLE RECORDING MEDIUM

(71) Applicant: NEC Corporation, Tokyo (JP)

(72) Inventors: Masaya FUJIWAKA, Tokyo (JP); Junichi FUNADA, Tokyo (JP); Jianquan LIU, Tokyo (JP); Ryo FURUKAWA, Tokyo (JP); Kazuya KAKIZAKI, Tokyo (JP); Yuto MATSUNAGA, Tokyo (JP); Toshinori ARAKI, Tokyo (JP)

(73) Assignee: NEC Corporation, Tokyo (JP)

(21) Appl. No.: 19/245,496

(22) Filed: Jun. 23, 2025

(30) Foreign Application Priority Data
Jul. 4, 2024 (JP) 2024-108424

(51) Int. Cl. G06V 20/70

(52) U.S. Cl. CPC G06V 20/70

(57) ABSTRACT

An information processing apparatus acquires a text associated with a target image which is an analysis target, and causes a generation model to generate an explanatory note of the target image according to content of the text. The generation model is obtained by performing machine learning to generate an explanatory note of an image. The information processing apparatus causes the generation model to generate a more detailed explanatory note of the target image by using the explanatory note generated by the generation model.

### INCORPORATION BY REFERENCE

This application is based upon and claims the benefit of priority from Japanese patent application No. 2024-108424, filed on Jul. 4, 2024, the disclosure of which is incorporated herein in its entirety by reference.

### TECHNICAL FIELD

The present disclosure relates to an information processing apparatus, an analysis method, and a non-transitory computer-readable recording medium.

### BACKGROUND ART

A language model capable of interpreting content of an image is known. For example, Patent Literature 1 describes a method of interpreting content of a drawing included in patent information by using a large language model capable of interpreting content of an image.
[Patent Literature 1] Japanese Patent No. 7421740

### SUMMARY

In a technique for causing a generation model such as a language model to generate an explanatory note of an image, there is room for improvement in the generation accuracy. An exemplary example object of the present disclosure is to provide a technique capable of improving generation accuracy of an explanatory note of an image.

According to a first example aspect, there is provided an information processing apparatus comprising:
at least one memory storing instructions; and
at least one processor executing the instructions to:
acquire a text associated with a target image which is an analysis target; and
input the acquired text to a generation model, which is obtained by performing machine learning to generate an explanatory note of an image, and cause the generation model to generate an explanatory note of the target image according to content of the text.

According to a second example aspect, there is provided an analysis method including:
acquisition processing of causing a computer to acquire a text associated with a target image which is an analysis target; and
explanatory note generation processing of causing the computer to input the acquired text to a generation model, which is obtained by performing machine learning to generate an explanatory note of an image, and causing the generation model to generate an explanatory note of the target image according to content of the text.

According to a third example aspect, there is provided a non-transitory computer-readable recording medium storing an analysis program causing a computer to execute:
acquisition processing of acquiring a text associated with a target image which is an analysis target; and
explanatory note generation processing of inputting the acquired text to a generation model, which is obtained by performing machine learning to generate an explanatory note of an image, and causing the generation model to generate an explanatory note of the target image according to content of the text.

According to the example aspects of the present disclosure, it is possible to provide a technique capable of improving generation accuracy of an explanatory note of an image.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an analysis method according to the present disclosure;

FIG. 3 is a block diagram illustrating a configuration of another information processing apparatus according to the present disclosure;

FIG. 4 is a diagram illustrating an example of truth/falsity determination using a generation model;

FIG. 5 is a flowchart illustrating an example of processing performed by the information processing apparatus illustrated in FIG. 3;

FIG. 6 is a flowchart illustrating a flow of processing of generating an explanatory note;

FIG. 7 is a flowchart illustrating a flow of processing of analyzing a target image;

FIG. 8 is a block diagram illustrating a configuration of a recording control apparatus according to the present disclosure;

FIG. 9 is a flowchart illustrating a flow of a recording control method according to the present disclosure;

FIG. 10 is a block diagram illustrating a configuration of a support apparatus according to the present disclosure;

FIG. 11 is a flowchart illustrating a flow of a support method according to the present disclosure;

FIG. 12 is a block diagram illustrating a configuration of an information processing apparatus according to a reference example;

FIG. 13 is a block diagram illustrating a configuration of an information processing apparatus according to another reference example; and

FIG. 14 is a block diagram illustrating a configuration of a computer that functions as an information processing apparatus, a recording control apparatus, and a support apparatus according to the present disclosure.

### EXAMPLE EMBODIMENTS

Hereinafter, example embodiments of the present disclosure will be exemplified. Here, the present disclosure is not limited to the example embodiments described below, and various modifications can be made within the scope described in the claims. For example, example embodiments obtained by appropriately combining techniques (some or all of things or methods) adopted in the following example embodiments can also be included in the scope of the present disclosure. In addition, example embodiments obtained by appropriately omitting some of the techniques adopted in the following example embodiments can also be included in the scope of the present disclosure. In addition, effects mentioned in the following example embodiments are examples of effects expected in the example embodiments, and do not define the extension of the present disclosure. That is, example embodiments that do not achieve the effects mentioned in the following example embodiments can also be included in the scope of the present disclosure.

### First Example Embodiment

A first example embodiment will be described in more detail with reference to the drawings. The present example embodiment is a basic form of each example embodiment to be described below. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in the drawings referred to for describing the present example embodiment can also be employed in the other example embodiments included in the present disclosure within a range in which no particular technical problem occurs.

### (Configuration of Information Processing Apparatus)

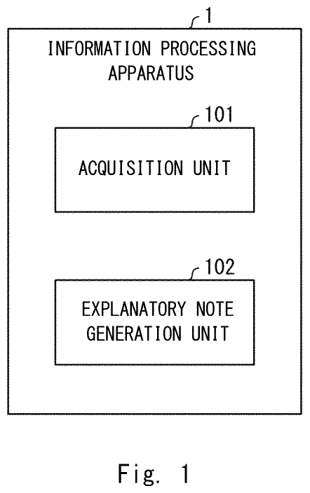

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes an acquisition unit 101 and an explanatory note generation unit 102.

The acquisition unit 101 acquires text associated with a target image which is an analysis target. Here, the target image may be either a still image or a moving image.

The text associated with the target image may be, for example, a text that is presented together with the target image for one topic in a specific page on the Internet, or a text that is a posted comment on the topic. In addition, the text may be a text that is presented together with a moving image provided from a moving image posting site or a video distribution site, or a text that is a posted comment on the moving image. Further, the text may be a text that is presented together with the target image for a specific post in a specific social networking service (SNS), or a text that is indicated by a hash tag on the post. Further, the text may be a text that is included in a predetermined file including the target image, a text that is included in a property of the file, or the like. The text associated with the target image is not necessarily provided from the same source. For example, a comment or the like that is posted on the SNS and is related to the target image published on a website may be used as a text associated with the target image.

The explanatory note generation unit 102 causes a generation model to generate an explanatory note of the target image according to content of the text, the generation model being obtained by performing machine learning to generate an explanatory note of an image. For example, the explanatory note generation unit 102 generates a prompt based on the description of the text that is acquired by the acquisition unit 101, and inputs the prompt to the generation model. Further, the explanatory note generation unit 102 inputs the target image to the generation model. Thereby, the explanatory note of the target image according to the prompt is output from the generation model. Here, the “explanatory note” is a text indicating the content of a part or the entire of the target image. Since the “explanatory note” only needs to indicate the content of the target image, the explanatory note can be rephrased as, for example, a summary or a summary note of the target image.

Here, the prompt generated by the explanatory note generation unit 102 may be generated by inputting the text acquired by the acquisition unit 101 into, for example, a fixed template. Further, the explanatory note generation unit 102 may input the text acquired by the acquisition unit 101 into a language model, and output a prompt to be input into the generation model. As the language model, for example, a model obtained by performing machine learning on arrangement of components (such as words) of a sentence and arrangement of sentences in a text may be applied. From the viewpoint of obtaining output with high accuracy, it is particularly preferable to use a large language model (LLM) generated by performing machine learning using a large-scale language corpus. For example, as an LLM to be used to extract assertion content, a generative pre-trained transformer (GPT) can be used, which predicts a character string that is likely to follow an input character string and outputs a sentence including the input character string. In addition to the GPT, as an LLM to be used to extract assertion content, for example, text-to-text transfer transformer (T5), bidirectional encoder representations from transformers (BERT), robustly optimized BERT approach (ROBERTa), or efficiently learning an encoder that classifies token replacements accurately (ELECTRA) may be used. The LLM is a language model, and is also a generation model that generates a character string.

Various known methods can be used for the generation model that is obtained by performing machine learning to generate an explanatory note of an image. For example, a text of an explanatory note of an image may be generated based on the prompt generated by the explanatory note generation unit 102 and the image by using, for example, a vision language model that receives a plurality of modalities as inputs and generates a text. The generation model may be a model obtained by performing machine learning to generate an explanatory note of a still image, a model obtained by performing machine learning to generate an explanatory note of a moving image, or a model obtained by performing machine learning to generate explanatory notes of both a still image and a moving image.

In addition, the generation model that converts content of an image into a text, the text output by the generation model, and the above-described prompt may be input to the language model to generate a text of an explanatory note of the image. Examples of the generation model that converts content of an image into a text include bootstrap language image pre-training (BLIP). Further, examples of a method of converting content of a moving image into a text include Video-LLaVa. Further, examples of a method of extracting a text in a moving image include an optical character recognition (OCR) technique such as vision transformer for fast and efficient scene text recognition (ViTSTR). The target image may be limited to an image in a specific field. For example, by limiting the target image to an image included in an article in the medical field, it is possible to generate an explanatory note for a technical image in the medical field. Further, for example, by limiting the target image to an image included in a healthcare-related document, it is also possible to generate an explanatory note of an image related to healthcare.

### (Effects of Information Processing Apparatus 1)

As described above, the information processing apparatus 1 employs a configuration including the acquisition unit 101 that acquires a text associated with a target image which is an analysis target, and the explanatory note generation unit 102 that causes the generation model to generate an explanatory note of the target image according to content of the text, the generation model being obtained by performing machine learning to generate an explanatory note of an image. Therefore, according to the information processing apparatus 1, it is possible to obtain an effect of improving the generation accuracy of the explanatory note of the image as compared with a case of simply using an output from a language model capable of interpreting content of an image. Further, according to the information processing apparatus 1, it is also possible to support decision making of the user in consideration of the generated explanatory note in addition to the target image.

### (Analysis Program)

The above-described functions of the information processing apparatus 1 can also be achieved by a program. The analysis program according to the present example embodiment causes a computer to function as the acquisition unit 101 that acquires a text associated with a target image which is an analysis target, and the explanatory note generation unit 102 that causes the generation model to generate an explanatory note of the target image according to content of the text, the generation model being obtained by performing machine learning to generate an explanatory note of an image. According to the analysis program, it is possible to obtain an effect of improving the generation accuracy of the explanatory note of the image as compared with a case of simply using an output from a language model capable of interpreting content of an image.

### (Analysis Method)

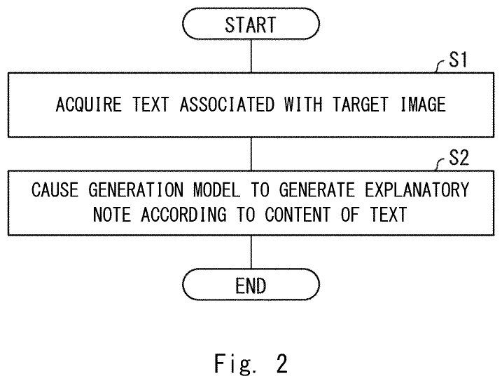

A flow of an analysis method according to the present example embodiment will be described with reference to FIG. 2. FIG. 2 is a flowchart illustrating a flow of the analysis method. An executing entity of each step in the analysis method may be a processor included in the information processing apparatus 1 or may be a processor included in another apparatus, or execution subjects of the respective steps may be processors provided in different apparatuses.

In step S1 (acquisition processing), at least one processor acquires a text associated with a target image which is an analysis target.

In step S2 (explanatory note generation processing), at least one processor causes the generation model to generate an explanatory note of the target image according to content of the text that is acquired in step S1, the generation model being obtained by performing machine learning to generate an explanatory note of an image.

### (Effects of Analysis Method)

As described above, the analysis method according to the present example embodiment employs a method causing at least one processor to perform acquisition processing of acquiring a text associated with a target image which is an analysis target, and explanatory note generation processing of causing the generation model to generate an explanatory note of the target image according to content of the text, the generation model being obtained by performing machine learning to generate an explanatory note of an image. Therefore, according to the analysis method according to the present example embodiment, it is possible to obtain an effect of improving the generation accuracy of the explanatory note of the image as compared with a case of simply using an output from a language model capable of interpreting content of an image.

### Second Example Embodiment

A second example embodiment will be described in more detail with reference to the drawings. Components having the same functions as the components described in the above-described example embodiment are denoted by the same reference signs, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be employed in the other example embodiments included in the present disclosure within a range in which no particular technical problem occurs.

### (Configuration of Information Processing Apparatus 1A)

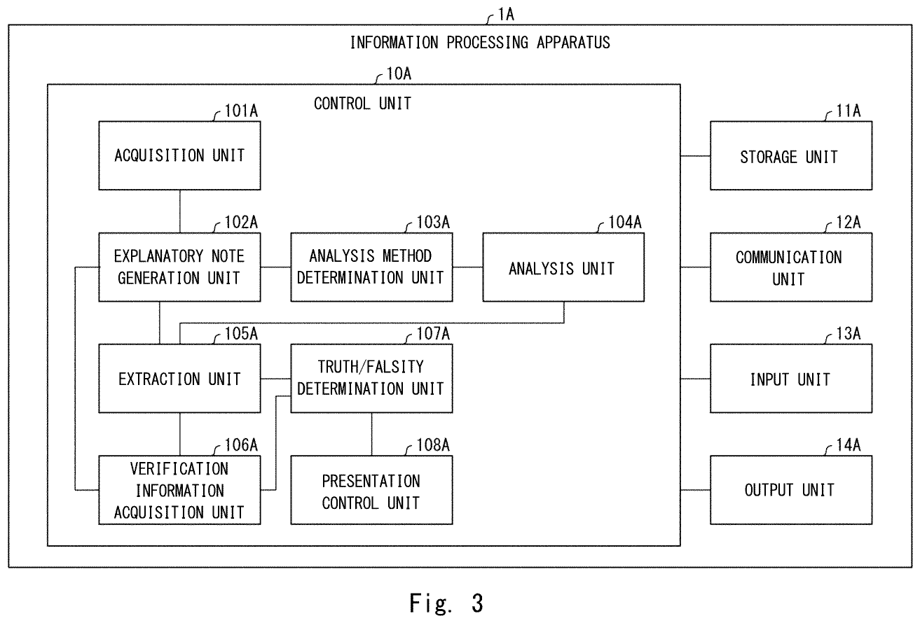

A configuration of an information processing apparatus 1A according to the present example embodiment will be described with reference to FIG. 3. FIG. 3 is a block diagram illustrating a configuration of the information processing apparatus 1A. The information processing apparatus 1A includes a control unit 10A that integrally controls units of the information processing apparatus 1A, and a storage unit 11A that stores various types of data to be used by the information processing apparatus 1A. Furthermore, the information processing apparatus 1A includes a communication unit 12A that allows the information processing apparatus 1A to perform communication with another apparatus, an input unit 13A that receives an input to the information processing apparatus 1A, and an output unit 14A that allows the information processing apparatus 1A to output data. Then, the control unit 10A includes an acquisition unit 101A, an explanatory note generation unit 102A, an analysis method determination unit 103A, an analysis unit 104A, an extraction unit 105A, a verification information acquisition unit 106A, a truth/falsity determination unit 107A, and a presentation control unit 108A.

The acquisition unit 101A acquires a text associated with a target image which is an analysis target, similarly to the acquisition unit 101 in the first example embodiment. In the present example embodiment, the acquisition unit 101A acquires content which is a target for determining truth/falsity of assertion content, and acquires an image included in the content as a target image.

Similar to the explanatory note generation unit 102 in the first example embodiment, the explanatory note generation unit 102A causes a generation model to generate an explanatory note of the target image according to the content of the text that is acquired by the acquisition unit 101A, the generation model being obtained by performing machine learning to generate an explanatory note of an image.

The analysis method determination unit 103A determines an analysis method to be applied to the target image, from among a plurality of analysis methods that can be applied to the target image, based on the explanatory note generated by the explanatory note generation unit 102A using the generation model. The analysis method determination unit 103A may determine one analysis method or a plurality of analysis methods.

The analysis unit 104A analyzes the target image by applying the analysis method determined by the analysis method determination unit 103A. For example, the analysis unit 104A may analyze the target image by using each of a plurality of analysis engines. In this case, the analysis method determination unit 103A determines an analysis engine to be used. Examples of the analysis engine include a person detection engine, an emotion analysis engine, an action recognition engine, a person tracking engine, a place detection engine, a driving video analysis engine, a voice recognition engine, and the like.

The person detection engine has a function of detecting a person appearing in an input image. Further, for example, by combining a person detection engine and a face analysis engine, it is also possible to perform analysis for specifying a detected person. The emotion analysis engine has a function of estimating an expression or an emotion of a person appearing in an input image. The action recognition engine has a function of recognizing an action of a person appearing in an input image. For example, an action of a person can be recognized by using a posture analysis engine that analyzes a posture of a person and a change in the analyzed posture. The person tracking engine has a function of tracking a person appearing in an input image. The place detection engine has a function of detecting a place appearing in an input image. The driving video analysis engine has a function of detecting a pedestrian, a signal, a vehicle, and the like appearing in a driving video in a case where an input image is a driving video obtained by imaging an external state during traveling of a vehicle. The voice recognition engine has a function of converting a voice associated with an input image into a text.

The extraction unit 105A extracts assertion content of the content that is a target for truth/falsity determination. For example, the extraction unit 105A generates an integrated explanatory note related to the target image, as a text indicating assertion content of the content, from the text of the explanatory note that is generated by the explanatory note generation unit 102A and the text of the analysis result that is generated by the analysis unit 104A. Here, the extraction unit 105A may generate an integrated explanatory note by simply combining the text of the explanatory note that is generated by the explanatory note generation unit 102A and the text of the analysis result that is generated by the analysis unit 104A.

In addition, the extraction unit 105A may input, to the LLM, the text of the explanatory note that is generated by the explanatory note generation unit 102A and the text of the analysis result that is generated by the analysis unit 104A, and output the content obtained by integrating the text of the explanatory note and the text of the analysis result, as an integrated explanatory note. In this case, the extraction unit 105A may access an LLM service provided on a cloud by the communication unit 12A via a communication network to use the LLM service, or may use an LLM processing unit built in the information processing apparatus 1A. Further, in a case where a text element is included in the content which is target of truth/falsity determination, the extraction unit 105A may also generate an integrated explanatory note by using the text element.

The verification information acquisition unit 106A acquires verification information which is as a basis for the truth/falsity determination by the truth/falsity determination unit 107A. For example, the verification information acquisition unit 106A acquires verification information based on at least one of the explanatory note generated by the explanatory note generation unit 102A and the integrated explanatory note extracted by the extraction unit 105A.

The verification information may be any information that can be used for the truth/falsity determination. In addition, a data format of the verification information is not particularly limited. In addition, multi-modal data including pieces of data in a plurality of data formats may be used as the verification information. For example, the verification information acquisition unit 106A may perform searching on a website based on the text acquired from at least one of the explanatory note generation unit 102A and the extraction unit 105A, and acquire text data, image data, voice data, and moving image data included in the website included in the search result, as multi-modal verification information. In addition, the verification information acquisition unit 106A may search for an image, a voice, and a moving image on the Internet based on the text acquired from at least one of the explanatory note generation unit 102A and the extraction unit 105A, and acquire image data, voice data, and moving image data as a search result. In addition, the search target is randomly set. For example, the verification information acquisition unit 106A may perform searching on a predetermined database, a predetermined data lake, or the like.

In addition, the verification information acquisition unit 106A may instruct the LLM to generate a word or a search expression to be used for search based on the text acquired from at least one of the explanatory note generation unit 102A and the extraction unit 105A. Then, the verification information acquisition unit 106A may perform the searching by using the word or the search expression generated by the LLM.

In addition, the verification information acquisition unit 106A may acquire the verification information from search results from the top to the predetermined rank in external information searching.

Further, for example, the verification information acquisition unit 106A may acquire the verification information that is input by the user of the information processing apparatus 1A via the communication unit 12A or the input unit 13A. Further, the verification information acquisition unit 106A may acquire, as the verification information, internal information such as data stored in advance in the storage unit 11A of the information processing apparatus 1A or data stored in a private network in which the information processing apparatus 1A exists.

In a case where the internal information is used as the verification information, the verification information acquisition unit 106A does not need to perform searching. The verification information acquisition unit 106A may search for internal information to be used as the verification information. As a searching method, a method similar to the case of using the external information as the verification information can be applied.

In addition, the verification information acquisition unit 106A may perform both searching for the external information described above and the acquisition of the internal information described above. That is, the verification information acquisition unit 106A may use, as the verification information, both the information acquired by the searching and the information acquired without searching.

Further, non-text element included in the multi-modal verification information acquired by the verification information acquisition unit 106A as described above may be converted into a text by the method of converting content of an image into a text. Here, in a case where the text obtained by the text conversion is too long or redundant, processing such as inputting the text into the LLM to summarize the text may be performed. Further, in a case where there are a plurality of text elements included in the verification information acquired by the verification information acquisition unit 106A as described above, the plurality of text elements may be combined to form one text. Similarly, in a case where there are a plurality of texts generated from non-text elements, the plurality of texts may be combined to form one text. In addition, the text element included in the verification information and the text generated from the non-text element may be combined to form one text. In these cases, truth/falsity determination is performed by using the integrated text. The integration method is randomly set. For example, the texts may be integrated by simply juxtaposing descriptions of the texts, or may be integrated by using a method causing the LLM to generate a summary of pieces of content of the plurality of texts.

The truth/falsity determination unit 107A determines a truth/falsity of the assertion content of the content acquired by the acquisition unit 101A. More specifically, the truth/falsity determination unit 107A determines a truth/falsity of the assertion content of the content by using the integrated explanatory note extracted by the extraction unit 105A. Specifically, the truth/falsity determination unit 107A first acquires the integrated explanatory note which is a target of the truth/falsity determination and is extracted by the extraction unit 105A. Further, the truth/falsity determination unit 107A acquires verification information which is a basis for the truth/falsity determination, from the verification information acquisition unit 106A.

Then, the truth/falsity determination unit 107A inputs, to the LLM that is a language model obtained by performing machine learning, the integrated explanatory note and the verification information for verifying the truth/falsity of the integrated explanatory note, generates an output indicating validity of the integrated explanatory note, and determines a truth/falsity of the integrated explanatory note based on the output. That is, the truth/falsity determination unit 107A generates a prompt to output the truth/falsity determination result of the integrated explanatory note, by using, as inputs, the integrated explanatory note extracted from the extraction unit 105A and the verification information (the non-text element is converted into a text as described above) that is acquired from the verification information acquisition unit 106A and is a basis of the truth/falsity determination, and inputs the generated prompt to the LLM. The truth/falsity determination result may be indicated by a binary value of “truth” or “falsity”, or may be indicated by evaluation results of a plurality of levels such as “truth”, “slight truth”, “slight falsity”, and “falsity”. Further, as the truth/falsity determination result, a degree of likelihood of “truth” may be indicated by a numerical value (for example, 0 to 100).

Further, the truth/falsity determination unit 107A may divide the integrated explanatory note into a plurality of parts, determine a truth/falsity for each part, and comprehensively determine the truth/falsity from each determination result.

Examples of the prompt include the following content. “The integrated explanatory note obtained from the target image and an evidence for determining the truth/falsity of the integrated explanatory note are provided. Your job is to determine whether the integrated explanatory note is correct based on the evidence. Please select between “true” and “false”.” Further, the prompt includes the integrated explanatory note generated by the extraction unit 105A and the verification information that is acquired by the verification information acquisition unit 106A and is a basis of the truth/falsity determination. In a case where such a prompt is input to the LLM, the truth/falsity determination result of the integrated explanatory note of the target image is output from the LLM.

The text input to the LLM may include the text associated with the target image in addition to the integrated explanatory note. In addition, it is not essential to include the analysis result of the target image in the input of the LLM. In the truth/falsity determination, it is sufficient that at least the text indicating the assertion content of the content and the text which indicates the content of the verification information and is an evidence for determining the truth/falsity of the content are input to the LLM.

The presentation control unit 108A presents the truth/falsity determination result generated by the truth/falsity determination unit 107A to the user. For example, the presentation control unit 108A may display a report indicating the truth/falsity determination result on a display device connected to the information processing apparatus 1A via the output unit 14A, or may transmit data indicating the report to an information processing terminal used by the user via a communication network by using the communication unit 12A.

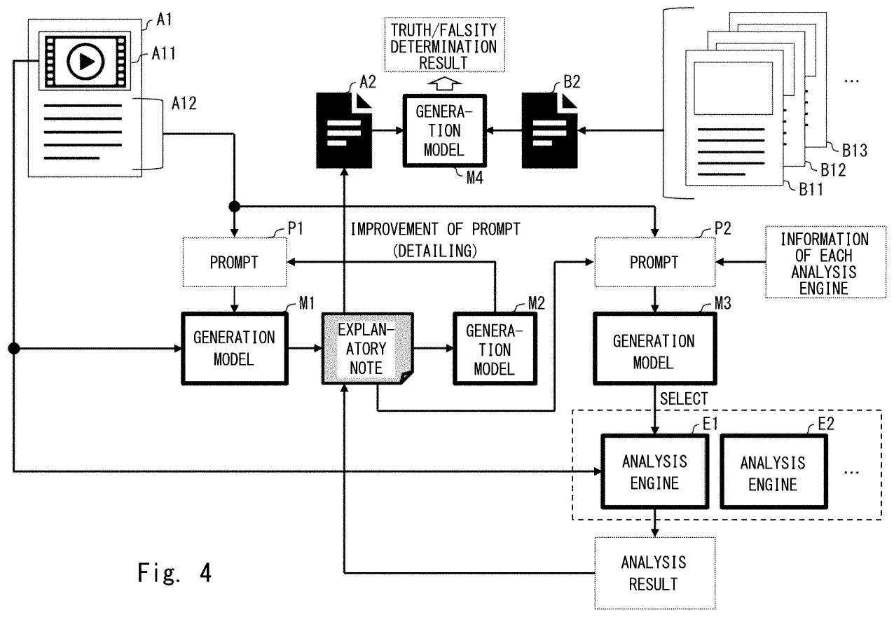

FIG. 4 is a diagram illustrating an example of the truth/falsity determination using the generation model. In the example of FIG. 4, the acquisition unit 101A acquires the text A12 which is associated with the target image A11 included in the content A1 that is a target of the truth/falsity determination. Then, the explanatory note generation unit 102A generates the prompt P1 based on the text A12 acquired by the acquisition unit 101A, and inputs the prompt P1 to the generation model M1 together with the target image A11 included in the content A1. The prompt P1 instructs generation of an explanatory note of the target image A11. In addition, the generation model M1 is a model obtained by performing machine learning to generate an explanatory note of an image. Thereby, the explanatory note of the target image A11 is output from the generation model M1.

For example, it is assumed that the text A12 indicates content of a speech of a candidate. In this case, the explanatory note generation unit 102A generates the prompt P1 for instructing generation of an explanatory note in consideration of the content of the text A12 (for example, “The input image is an image obtained by imaging a speech of a candidate. Please output what you can read about the candidate from the image.” or the like). Then, the explanatory note generation unit 102A can generate an explanatory note such as “the candidate is making a speech outdoors”, for example, by inputting the prompt P1 to the generation model M1.

In general, since an image has a large amount of information, a desired explanatory note cannot be often obtained by a prompt such as “Please summarize the video”. For example, in a case where the target image A11 is an image obtained by imaging a speech of a candidate, an explanatory note for an object other than the candidate (for example, a place where the candidate is making a speech, a person around the candidate, or the like) may be generated. In this regard, since the explanatory note generation unit 102A generates an explanatory note according to the content of the text A12, it is possible to generate an explanatory note suitable for truth/falsity determination, the explanatory note having the same granularity as the content of the text A12.

In addition, the explanatory note generation unit 102A causes the generation model M1 to generate a more detailed explanatory note of the target image A11 by using the explanatory note generated by the generation model M1. Specifically, by inputting the explanatory note generated by the generation model M1 to the generation model M2, the explanatory note generation unit 102A changes the prompt P1 to be input to the generation model M1, to content for generation of a more detailed explanatory note. The generation model M2 only needs to be a language model obtained by performing machine learning to output a text according to the content of the prompt in a text format.

For example, as described above, the prompt P1 that is first input indicates “The input image is an image obtained by imaging a speech of a candidate. Please output what you can read about the candidate from the image.” In response to the prompt P1, an explanatory note indicating “The candidate is making a speech outdoors.” is generated.

In this case, the explanatory note generation unit 102A improves (can also be referred to as detailing) the prompt P1 by using the explanatory note “The candidate is making a speech outdoors”. The improved prompt P1 may be, for example, “The input image is an image obtained by imaging a speech of a candidate. Please output what you can read about the candidate from the image. If you know where the outdoors is, please also input the place. If a name of the candidate is known, please also input the name”. By inputting the prompt P1 improved in this way to the generation model M1 together with the target image A11, it is possible to output an explanatory note in which the content of the target image A11 is described in more detail.

In addition, the explanatory note generation unit 102A may repeatedly perform processing of causing the generation model M2 to generate a more detailed explanatory note of the target image A11 until the content of the generated explanatory note is no longer improved. Specifically, the explanatory note generation unit 102A repeats processing of inputting, to the generation model M1, the prompt P1 generated by the explanatory note generated by the generation model M1, until there is no substantial change in the explanatory note output from the generation model M1. Thereby, it is possible to output the explanatory note of the target image A11 improved to the maximum.

Next, the analysis method determination unit 103A generates a prompt P2 for determining an analysis method to be applied to the target image A11, based on the explanatory note generated by the generation model M1. The prompt P2 may include an explanatory note generated by the generation model M1 and information related to each of the analysis methods that can be executed by the analysis unit 104A. For example, in a case where an analysis engine to be used is selected from among a plurality of analysis engines as described above, the prompt P2 may include a text describing analysis content of each analysis engine, an image to be used for analysis, and the like. In addition, the prompt P2 may include the content of the text A12. The prompt P2 is input to the generation model M3, and an analysis method to be applied to the target image A11 is output. The generation model M3 only needs to be a language model obtained by performing machine learning to output a text according to the content of the prompt in a text format.

Next, the analysis unit 104A analyzes the target image A11 by using the analysis engine selected by the analysis method determination unit 103A, and outputs an analysis result. For example, in the example of FIG. 4, the analysis engine E1 is selected from the analysis engines E1 and E2. Therefore, the analysis unit 104A analyzes the target image A11 by using the analysis engine E1, and outputs an analysis result.

For example, the extraction unit 105A generates an integrated explanatory note A2 related to the target image, from the text of the explanatory note that is generated by the explanatory note generation unit 102A and the text of the analysis result that is generated by the analysis unit 104A.

In addition, the verification information acquisition unit 106A acquires pieces of verification information B11, B12, B13, . . . that are a basis for the truth/falsity determination by the truth/falsity determination unit 107A, based on at least one of the explanatory note generated by the explanatory note generation unit 102A and the integrated explanatory note generated by the extraction unit 105A. Then, the verification information acquisition unit 106A generates integrated verification information B2 based on the pieces of verification information B11, B12, B13, . . . . The verification can be performed by using the individual pieces of verification information B11, B12, B13 . . . without generating the integrated verification information B2.

Thereafter, the truth/falsity determination unit 107A inputs, to the generation model M4, the text indicating the integrated explanatory note A2 and the integrated verification information B2 for verifying the truth/falsity of the integrated explanatory note, and outputs a truth/falsity determination result of the integrated explanatory note A2.

The generation models M2 to M4 may be language models having the same type, or may be language models having different types. In addition, improvement of the prompt P1, selection of the analysis method, and truth/falsity determination may be performed by the same generation model.

### (Analysis Method)

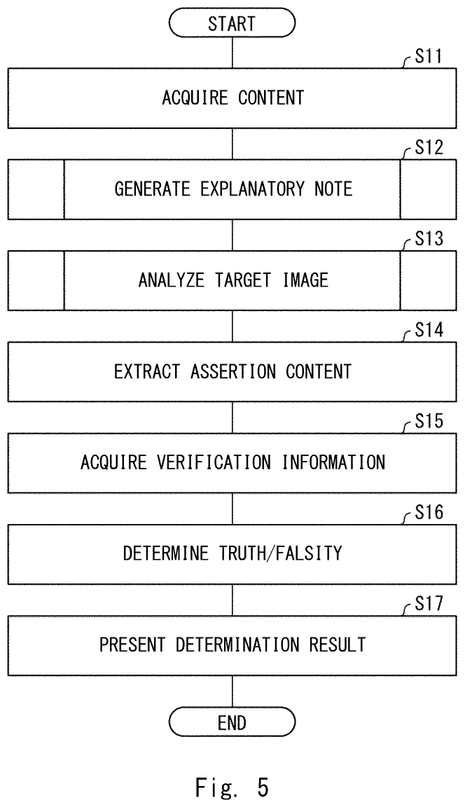

A flow of processing executed by the information processing apparatus 1A will be described with reference to FIG. 5. FIG. 5 is a flowchart illustrating an example of the processing performed by the information processing apparatus 1A.

In step S11, the acquisition unit 101A acquires content that is a target for truth/falsity determination. The content acquisition method is randomly set. For example, the acquisition unit 101A may acquire content that is input via the communication unit 12A or the input unit 13A. Further, for example, the acquisition unit 101A may automatically acquire content from a predetermined acquisition source.

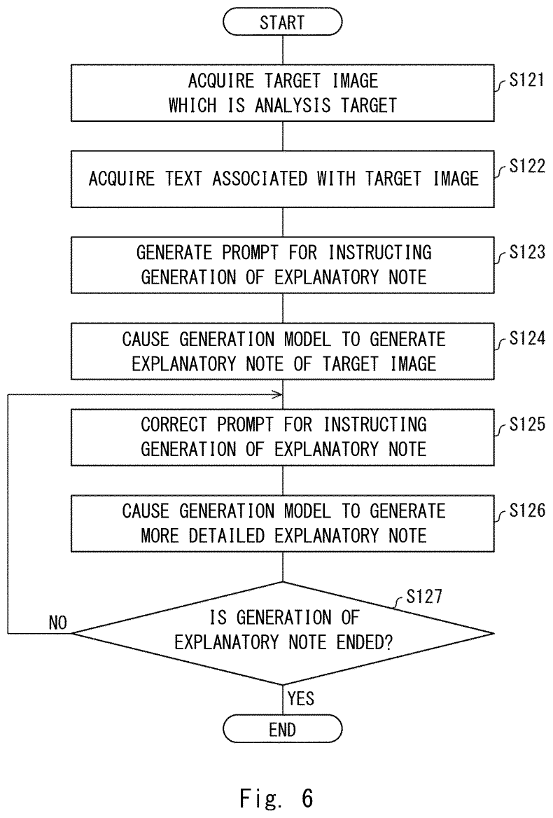

In step S12, the explanatory note generation unit 102A generates an explanatory note of the target image included in the content acquired in step S11. Details of step S12 will be described later with reference to FIG. 6.

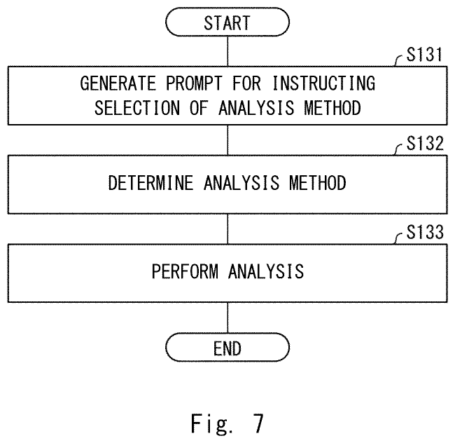

In step S13, the target image included in the content acquired in step S11 is analyzed. Details of step S13 will be described later with reference to FIG. 7.

In step S14, the extraction unit 105A extracts assertion content of the content acquired in step S11. Specifically, the extraction unit 105A generates an integrated explanatory note related to the target image, from the text of the explanatory note that is generated by the explanatory note generation unit 102A in step S12 and the text of the analysis result that is generated by the analysis unit 104A in step S13.

In step S15, the verification information acquisition unit 106A acquires verification information that is a basis for the truth/falsity determination, based on at least one of the explanatory note that is generated in step S12 and the integrated explanatory note that is extracted in step S14. As described above, either or both of the external information and the internal information may be acquired as the verification information. Further, in a case where the acquired verification information includes a non-text element, the non-text element may be converted into a text and the text may be used as the verification information.

In step S16, the truth/falsity determination unit 107A determines the truth/falsity of the content that is acquired in step S11 based on the verification information acquired in step S15. Specifically, the truth/falsity determination unit 107A inputs, to the LLM, the integrated explanatory note generated in step S14 and the verification information acquired in step S15, and outputs a truth/falsity determination result.

In step S17, the presentation control unit 108A presents the truth/falsity determination result (determination result) generated by the truth/falsity determination unit 107A in step S16 to the user. The presentation control unit 108A may present a report including basis information indicating the basis of the determination result, in addition to the determination result of the truth/falsity of the assertion content. For example, the report can be generated by the LLM by inputting, to the LLM, a description of the verification target and information indicating the verification process in addition to the determination result of the truth/falsity determination unit 107A.

### (Flow of Generation of Explanatory Note)

Next, a flow of processing of generating an explanatory note in step S12 will be described with reference to FIG. 6. FIG. 6 is a flowchart illustrating a flow of processing of generating an explanatory note. FIG. 6 includes processes of the analysis method according to the present example embodiment.

In step S121, the acquisition unit 101A acquires the target image from the content acquired in step S11 of FIG. 5. The execution order of processing of step S121 and processing of step S122 to be described below is randomly set. The processing of step S122 may be executed first, or the processing of step S121 and the processing of step S122 may be executed in parallel.

In step S122 (acquisition processing), the acquisition unit 101A acquires the text associated with the target image acquired in step S121. For example, the acquisition unit 101A may acquire, as the text associated with the target image, a description portion that is related to the target image and is included in the content acquired in step S11 of FIG. 5. Further, for example, the acquisition unit 101A may acquire, as the text associated with the target image, a comment such as an SNS for the content acquired in step S11 of FIG. 5.

In step S123, the explanatory note generation unit 102A generates a prompt for instructing the generation model to generate an explanatory note based on the text acquired in step S122.

In step S124 (explanatory note generation processing), the explanatory note generation unit 102A inputs the prompt generated in step S123 to the generation model together with the target image acquired in step S121, and causes the generation model to generate an explanatory note of the target image.

In step S125, the explanatory note generation unit 102A corrects the prompt generated in step S123 by using the explanatory note generated in step S124. For example, the explanatory note generation unit 102A may generate, according to the content of the explanatory note generated in step S124, a prompt for instructing generation of a more detailed explanatory note, input the prompt to the LLM, and output a corrected prompt. In a case where NO is determined in step S127 to be described later, processing of step S125 is performed again. At this time, the prompt is corrected by using the explanatory note generated in step S126 instead of the explanatory note generated in step S124.

In step S126, the explanatory note generation unit 102A inputs the prompt generated in step S125 to the generation model that generates an explanatory note, and causes the generation model to generate an explanatory note of the target image.

In step S127, the explanatory note generation unit 102A determines whether to end generation of the explanatory note by confirming whether the content of the explanatory note generated by the generation model has been improved. Whether the content of the explanatory note has been improved can be determined, for example, by inputting a previously-generated explanatory note and a newly-generated explanatory note to the LLM and outputting whether there is a change in the content of these question comments. In a case where NO is determined in step S127, that is, in a case where it is determined that generation of the explanatory note should be performed again, processing from step S125 is performed. On the other hand, in a case where YES is determined in step S127, that is, in a case where it is determined that generation of the explanatory note should be ended, the generation processing of the explanatory note in step S12 is ended. The processing of step S125 to step S127 is not essential, and can be omitted.

### (Flow of Target Image Analysis)

Next, a flow of target image analysis processing in step S13 of FIG. 5 will be described with reference to FIG. 7. FIG. 7 is a flowchart illustrating a flow of processing of analyzing a target image.

In step S131, the analysis method determination unit 103A generates a prompt for selecting an analysis engine to be executed in the analysis unit 104A based on the explanatory note generated in the processing of step S126 in FIG. 6. In a case where the processing of step S126 of FIG. 6 has been performed a plurality of times, the analysis method determination unit 103A generates a prompt based on the explanatory note generated in the processing of step S126 performed last. In addition, in a case where the processing of step S125 to step S127 is omitted, a prompt is generated based on the explanatory note generated in step S124.

In step S132, the analysis method determination unit 103A inputs the prompt generated in step S131 to the LLM, outputs an analysis method to be executed. Thus, the analysis method is determined. As described above, the analysis method determination unit 103A may output, for example, an analysis engine to be used for analysis.

In step S133, the analysis unit 104A analyzes the target image by applying the analysis method determined by the analysis method determination unit 103A, and outputs an analysis result.

### (Effects of Information Processing Apparatus 1A)

As described above, the information processing apparatus 1A includes the acquisition unit 101A that acquires a text associated with a target image which is an analysis target, and the explanatory note generation unit 102A that causes the generation model to generate an explanatory note of the target image according to content of the text, the generation model being obtained by performing machine learning to generate an explanatory note of an image. Therefore, according to the information processing apparatus 1A, similarly to the information processing apparatus 1, it is possible to obtain an effect capable of improving the generation accuracy of the explanatory note of the image.

Further, as described above, in the information processing apparatus 1A, the explanatory note generation unit 102A causes the generation model to generate a more detailed explanatory note of the target image by using the explanatory note generated by the generation model. Therefore, according to the information processing apparatus 1A, in addition to the effect obtained by the information processing apparatus 1, it is possible to obtain an effect capable of outputting a further-improved explanatory note of the target image.

Further, in the information processing apparatus 1A, the explanatory note generation unit 102A repeatedly performs processing of causing the generation model to generate a more detailed explanatory note of the target image until the content of the generated explanatory note is no longer improved. Therefore, according to the information processing apparatus 1A, in addition to the effect obtained by the information processing apparatus 1, it is possible to obtain an effect capable of outputting a maximally-improved explanatory note of the target image.

Further, the information processing apparatus 1A includes the analysis method determination unit 103A that determines an analysis method to be applied to the target image, from among a plurality of analysis methods that can be applied to the target image, based on the explanatory note generated by the generation model. Therefore, according to the information processing apparatus 1A, in addition to the effect obtained by the information processing apparatus 1, it is possible to obtain an effect capable of analyzing the target image by an appropriate analysis method according to the content of the target image.

Further, the information processing apparatus 1A employs a configuration including an acquisition unit 101A that acquires a target image which is an analysis target, and an explanatory note generation unit 102A that causes a generation model to generate an explanatory note of the target image, the generation model being obtained by performing machine learning to generate an explanatory note of an image. The explanatory note generation unit 102A causes the generation model to generate a more detailed explanatory note of the target image by using the explanatory note generated by the generation model. Therefore, according to the information processing apparatus 1A, it is possible to obtain an effect capable of improving the generation accuracy of the explanatory note of the image as compared with a case of simply using an output from a language model capable of interpreting content of an image.

Further, the information processing apparatus 1A employs a configuration including an explanatory note generation unit 102A that causes a generation model to generate an explanatory note of a target image which is an analysis target, the generation model being obtained by performing machine learning to generate an explanatory note of an image, and an analysis method determination unit 103A that determines an analysis method to be applied to the target image, from among a plurality of analysis methods that can be applied to the target image, based on the explanatory note generated by the generation model. Therefore, according to the information processing apparatus 1A, it is possible to obtain an effect capable of analyzing the target image by an appropriate analysis method according to the content of the target image.

Further, the information processing apparatus 1A has a function of determining the truth/falsity of the assertion content of the content, and thus, the information processing apparatus 1A can also be referred to as a verification apparatus. That is, the verification apparatus described in the second example embodiment employs a configuration including an explanatory note generation unit 102A that causes a generation model to generate, according to content of a text associated with content which is a target of truth/falsity determination, an explanatory note of an image included in the content, the generation model being obtained by performing machine learning to generate an explanatory note of an image, and a truth/falsity determination unit 107A that determines truth/falsity of assertion content of the content based on the explanatory note generated by the generation model. According to the verification apparatus employing such a configuration, it is possible to obtain an effect capable of automatically determining the truth/falsity of the assertion content of the content in consideration of the target image included in the content and the text associated with the target image.

### Third Example Embodiment

A third example embodiment will be described in more detail with reference to the drawings. Components having the same functions as the components described in the above-described example embodiment are denoted by the same reference signs, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be employed in the other example embodiments included in the present disclosure within a range in which no particular technical problem occurs.

### (Configuration of Recording Control Apparatus 1B)

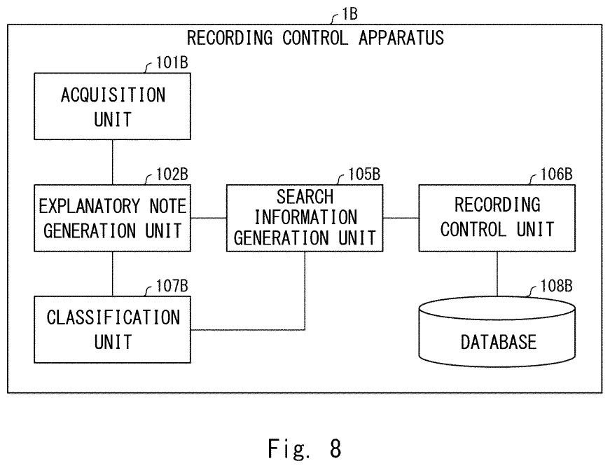

A configuration of a recording control apparatus 1B according to the present example embodiment will be described with reference to FIG. 8. FIG. 8 is a block diagram illustrating a configuration of a recording control apparatus 1B. The recording control apparatus 1B includes an acquisition unit 101B, an explanatory note generation unit 102B, a search information generation unit 105B, a recording control unit 106B, a classification unit 107B, and a database 108B.

The recording control apparatus 1B is an apparatus having a function of generating a database of images. More specifically, the recording control apparatus 1B acquires an image to be recorded in the database 108B, generates search information for searching for the acquired image, and records the acquired image in the database 108B in association with the search information. The recording control apparatus 1B uses an explanatory note of an image to be recorded, as information that is a source of the search information.

The acquisition unit 101B acquires a target image to be recorded in the database 108B. The target image may be a moving image or a still image. In addition, the acquisition unit 101B acquires a text associated with the target image. For example, the acquisition unit 101B may acquire at least one of a file name of the target image, a caption given in advance to the target image, and a feedback comment on the target image by the viewer of the target image, as a text associated with the target image.

The explanatory note generation unit 102B causes a generation model to generate an explanatory note of the target image according to the content of the text associated with the target image to be recorded in the database 108B, the generation model being obtained by performing machine learning to generate an explanatory note of an image. As the generation model, a model similar to the model described in the first and second example embodiments can be applied. The generated explanatory note is used for generating the search information, and thus, the explanatory note generation unit 102B may generate a prompt for instructing generation of an explanatory note including information useful for search, and input the prompt into the generation model together with the target image.

The search information generation unit 105B generates search information for searching for the target image from the database 108B based on the explanatory note generated by the generation model. For example, the search information generation unit 105B may use a word extracted from the explanatory note, as the search information. Further, for example, the search information generation unit 105B may input the explanatory note to the LLM, and generate information (for example, a search tag) for searching for the image according to the content of the explanatory note.

The recording control unit 106B records the search information generated by the search information generation unit 105B in association with the target image. In addition, the recording control unit 106B may record a classification result of the classification unit 107B to be described below, as the search information. In a case where the explanatory note generated by the explanatory note generation unit 102B can be used as search information such as a summary or a caption of an image, the recording control unit 106B may record the explanatory note as the search information. In this case, the search information generation unit 105B can be omitted. Further, the classification result of the classification unit 107B may be recorded as the search information, and the search information generation unit 105B may be omitted.

The classification unit 107B classifies the target image based on the explanatory note generated using the generation model by the explanatory note generation unit 102B. A category to be used for classification of the target image may be determined in advance. Further, the classification method is not particularly limited. For example, the classification unit 107B may input the explanatory note and each target category to the LLM, and output a category suitable for the explanatory note.

The database 108B is a database that records images. Data other than images may also be recorded in the database 108B. Although FIG. 8 illustrates an example in which the database 108B is provided inside the recording control apparatus 1B, the database may be provided outside the recording control apparatus 1B. In addition, the recording control apparatus 1B may record the target images in a plurality of databases in a distributed manner. For example, the recording control apparatus 1B may record the target images in different databases for each classification result of the classification unit 107B.

As described above, the recording control apparatus 1B includes an explanatory note generation unit 102B that causes a generation model to generate an explanatory note of a target image according to content of a text associated with a target image to be recorded in a database 108B, the generation model being obtained by performing machine learning to generate an explanatory note of an image, and a recording control unit 106B that records search information which is for searching for, from the database 108B, the target image and is generated based on the explanatory note generated by the generation model, in association with the target image. Therefore, according to the recording control apparatus 1B, it is possible to obtain an effect capable of searching for the target image recorded in the database 108B with high accuracy.

In addition, as described above, the recording control apparatus 1B includes the classification unit 107B that classifies the target image based on the explanatory note generated using the generation model by the explanatory note generation unit 102B, and the recording control unit 106B records the classification result of the classification unit 107B in association with the target image. Thereby, it is possible to obtain an effect capable of searching for the target data recorded in the database 108B by using the classification without performing manual classification.

### (Recording Control Program)

The above-described functions of the recording control apparatus 1B can also be achieved by a program. A recording control program according to the present example embodiment causes a computer to function as an explanatory note generation unit 102B that causes a generation model to generate an explanatory note of a target image according to content of a text associated with a target image to be recorded in a database 108B, the generation model being obtained by performing machine learning to generate an explanatory note of an image, and a recording control unit 106B that records search information which is for searching for, from the database 108B, the target image and is generated based on the explanatory note generated by the generation model, in association with the target image. Therefore, according to the recording control program, it is possible to obtain an effect capable of searching for the target image recorded in the database 108B with high accuracy.

### (Recording Control Method)

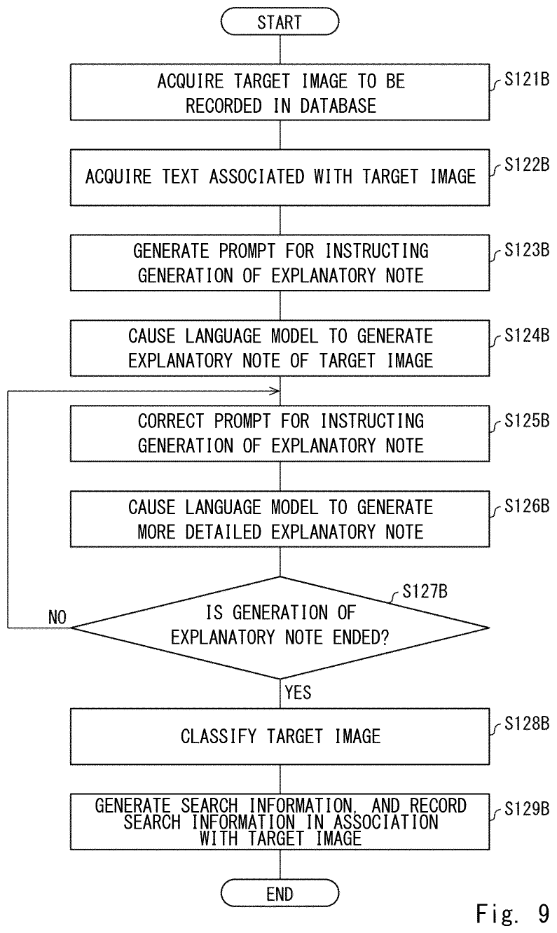

A flow of processing executed by the recording control apparatus 1B will be described with reference to FIG. 9. FIG. 9 is a flowchart illustrating an example of processing executed by the recording control apparatus 1B. FIG. 9 includes pieces of processing of the recording control method according to the present example embodiment.

In step S121B, the acquisition unit 101B acquires a target image to be recorded in the database 108B. In step S122B, the acquisition unit 101B acquires a text associated with the target image. The processing of step S122B may be performed first, and then the processing of step S121B may be performed, or pieces of processing of step S121B and step S122B may be performed in parallel.

In step S123B, the explanatory note generation unit 102B generates a prompt for instructing generation of an explanatory note of the target image according to the content of the text acquired in step S122B.

In step S124B (explanatory note generation processing), the explanatory note generation unit 102B causes the generation model to generate an explanatory note of the target image according to content of the text that is acquired in step S122B, the generation model being obtained by performing machine learning to generate an explanatory note of an image. Specifically, the explanatory note generation unit 102B inputs the prompt generated in step S123B to the generation model together with the target image acquired in step S121B and the text acquired in step S122B, and causes the generation model to generate an explanatory note.

The processing of step S125B to step S127B is similar to the processing of step S125 to step S127 of FIG. 6, the description thereof will not be repeated here. The processing of step S125B to step S127B may be omitted, and the processing may proceed to step S128B after step S124B. In a case where the processing of step S125B to step S127B is omitted, the explanatory note generated in step S124B is used in step S128B and step S129B to be described later.

In step S128B, the classification unit 107B classifies the target image based on the final explanatory note generated by repeating the processing of step S125B to step S127B. As described above, in a case where the processing of step S125B to step S127B is omitted, the explanatory note generated in step S124B is used for the classification of step S128B.

In step S129B, the search information generation unit 105B generates search information for searching for the target image from the database 108B based on the explanatory note generated by the generation model. The explanatory note to be used is a final explanatory note generated by repeating the processing of step S125B to step S127B. As described above, in a case where the processing of step S125B to step S127B is omitted, in step S129B, the explanatory note generated in step S124B is used.

In addition, in step S129B, the recording control unit 106B records the search information generated by the search information generation unit 105B in association with the target image acquired in step S121B (recording control processing). In addition, the recording control unit 106B also records the classification result of step S128B in association with the target image. Thereby, the processing of FIG. 9 is ended.

As described above, it is not essential to generate the search information. Further, the classification result by the classification unit 107B may be used as the search information. That is, in step S129B, the recording control unit 106B may record the final explanatory note generated by repeating the processing of step S125B to step S127B or the explanatory note generated in the processing of step S124B, as the search information. Further, the recording control unit 106B may record the classification result of step S128B, as the search information.

As described above, the recording control method according to the present example embodiment includes explanatory note generation processing of causing a generation model to generate an explanatory note of a target image according to content of a text associated with the target image to be recorded in a database 108B, the generation model being obtained by performing machine learning to generate an explanatory note of an image, and recording control processing of recording search information which is for searching for, from the database 108B, the target image and is generated based on the explanatory note generated by the generation model, in association with the target image. Therefore, according to the recording control method, it is possible to obtain an effect capable of searching for the target image recorded in the database 108B with high accuracy.

### Fourth Example Embodiment

A fourth example embodiment will be described in more detail with reference to the drawings. Components having the same functions as the components described in the above-described example embodiment are denoted by the same reference signs, and the description thereof will be appropriately omitted. An application range of each technique adopted in the present example embodiment is not limited to the present example embodiment. That is, each technique adopted in the present example embodiment can also be adopted in the other example embodiments included in the present disclosure within a range in which no particular technical problem occurs. In addition, each technique illustrated in each of the drawings referred to for describing the present example embodiment can be employed in the other example embodiments included in the present disclosure within a range in which no particular technical problem occurs.

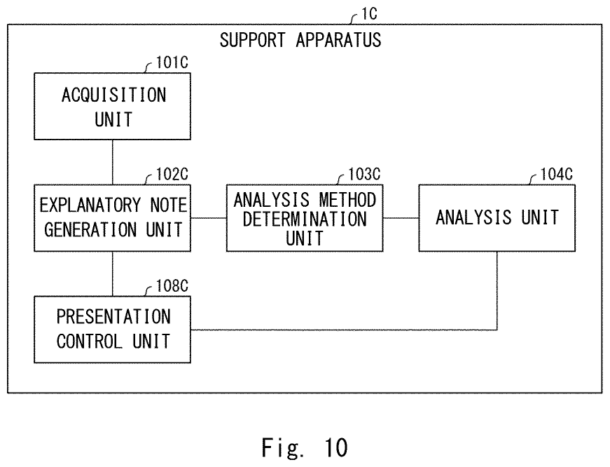

(Configuration of Support Apparatus 1C) A configuration of a support apparatus 1C according to the present example embodiment will be described with reference to FIG. 10. FIG. 10 is a block diagram illustrating a configuration of the support apparatus 1C. The support apparatus 1C includes an acquisition unit 101C, an explanatory note generation unit 102C, an analysis method determination unit 103C, an analysis unit 104C, and a presentation control unit 108C. The support apparatus 1C is an apparatus that supports disaster response.

The acquisition unit 101C acquires an image obtained by imaging a disaster site, as a target image which is an analysis target. The target image may be a moving image or a still image. The acquisition unit 101C may acquire various types of information related to the target image, as related information, in addition to the target image. For example, the acquisition unit 101C may acquire the related information indicating a name of a region where imaging of the target image is performed, a type of disaster, and the like. The related information may be information in a text format or information in another format. The related information in another format may be converted into a text format and may be used by the acquisition unit 101C or the explanatory note generation unit 102A.

The explanatory note generation unit 102C causes a generation model to generate an explanatory note of the target image acquired by the acquisition unit 101C, that is, the image obtained by imaging a disaster site, the generation model being obtained by performing machine learning to generate an explanatory note of an image. As the generation model, a model similar to the model described in the example embodiments 1 to 3 can be applied. The generated explanatory note is used for determining the analysis method, and thus, the explanatory note generation unit 102C may generate a prompt for instructing generation of an explanatory note including information useful for determination of the analysis method, and input the prompt into the generation model together with the target image.

The analysis method determination unit 103C determines an analysis method to be applied to the target image, from among a plurality of analysis methods that can be applied to the target image, based on the explanatory note generated by the generation model. As the analysis method, each analysis method described in the second example embodiment can be applied.

Similarly to the analysis unit 104A of the second example embodiment, the analysis unit 104C analyzes the target image by applying the analysis method determined by the analysis method determination unit 103C.

The presentation control unit 108C presents the analysis result of the analysis unit 104C to the user. A form of the presentation is randomly set. For example, the presentation control unit 108C may present the analysis result to the user by displaying the analysis results superimposed on the target image.

As described above, the support apparatus 1C includes the explanatory note generation unit 102C that causes a generation model to generate an explanatory note of a target image which is obtained by imaging a disaster site, the generation model being obtained by performing machine learning to generate an explanatory note of an image, and the analysis method determination unit 103C that determines an analysis method to be applied to the target image, from among a plurality of analysis methods that can be applied to the target image, based on the explanatory note generated by the generation model.

Here, at a disaster site, situations that cannot be predicted in advance may occur. For example, at a disaster site, a building may collapse, soil and debris may flow, or a person may have fallen. In addition, analysis methods to be applied are different depending on the situation of the disaster site. For example, in a case where a person has fallen, it is necessary to detect the person and determine a condition of the person, and in a case where a building has collapsed, it is necessary to analyze an extent of the collapse and a cause of the collapse.

In this regard, according to the support apparatus 1C, even in a case where an unexpected situation occurs at a disaster site, an explanatory note indicating a state of the disaster site is generated, and an analysis method is determined based on the explanatory note. Therefore, an appropriate analysis method according to the state of the disaster site can be applied. Therefore, according to the support apparatus 1C, it is possible to obtain an effect capable of contributing to accurate and rapid disaster response.

### (Support Program)

The above-described functions of the support apparatus 1C can also be achieved by a program. A support program according to the present example embodiment causes a computer to function as the explanatory note generation unit 102C that causes a generation model to generate an explanatory note of a target image which is obtained by imaging a disaster site, the generation model being obtained by performing machine learning to generate an explanatory note of an image, and the analysis method determination unit 103C that determines an analysis method to be applied to the target image, from among a plurality of analysis methods that can be applied to the target image, based on the explanatory note generated by the generation model. According to the support program, it is possible to obtain an effect capable of contributing to accurate and rapid disaster response.

### (Support Method)

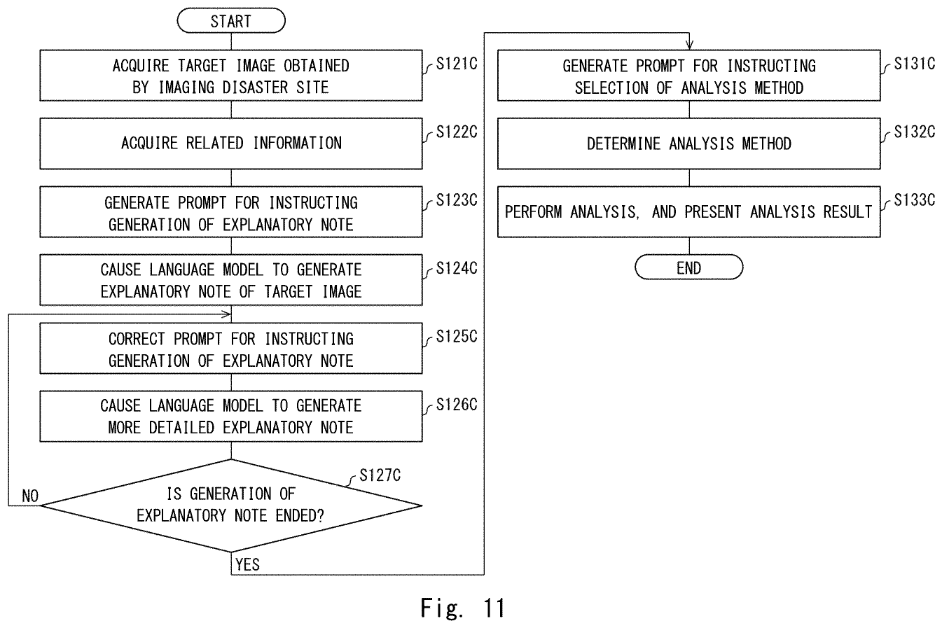

A flow of processing executed by the support apparatus 1C will be described with reference to FIG. 11. FIG. 11 is a flowchart illustrating an example of processing executed by the support apparatus 1C. FIG. 11 includes processes of the support method according to the present example embodiment.

In step S121C, the acquisition unit 101C acquires an image obtained by imaging a disaster site, as a target image which is an analysis target. The acquisition method of the target image is randomly set. For example, the acquisition unit 101C may acquire the target image that is input by the user to the support apparatus 1C, or may acquire the target image from another apparatus by communication.

In step S122C, the acquisition unit 101C acquires the related information. Similar to the target image, the acquisition method of the related information is also randomly set. The processing of step S122C may be performed before step S121C, or may be performed in parallel with step S121C. Further, in a case where the related information cannot be acquired or in a case where the related information does not need to be used, the processing of step S122C may be omitted.

In step S123C, the explanatory note generation unit 102C generates a prompt for instructing generation of an explanatory note of the target image according to the content of the related information acquired in step S122C.

In step S124C (explanatory note generation processing), the explanatory note generation unit 102C causes a generation model to generate an explanatory note of the target image obtained by imaging a disaster site, the generation model being obtained by performing machine learning to generate an explanatory note of an image. Specifically, the explanatory note generation unit 102C inputs the prompt generated in step S123C to the generation model together with the target image acquired in step S121C and the related information acquired in step S122C, and causes the generation model to generate an explanatory note.

The processing of step S125C to step S127C is similar to the processing of step S125 to step S127 of FIG. 6, the description thereof will not be repeated here. The processing of step S125C to step S127C may be omitted, and the processing may proceed to step S128C after step S124C. In a case where the processing of step S125C to step S127C is omitted, the explanatory note generated in step S124C is used in step S131C and step S132C to be described later.

In step S131C, the analysis method determination unit 103C generates a prompt for instructing selection of an analysis method to be applied to the target image, from among a plurality of analysis methods that can be applied to the target image, according to the explanatory note generated by the generation model. Further, the analysis method determination unit 103C may also include, in the prompt, the related information acquired in step S122C.

In step S132C (analysis method determination processing), the analysis method determination unit 103C determines an analysis method to be applied to the target image, from among a plurality of analysis methods that can be applied to the target image, based on the explanatory note generated by the generation model. Specifically, the analysis method determination unit 103C inputs the prompt generated in step S131C to the language model together with the target image acquired in step S121C and the related information acquired in step S122C. Then, the analysis method determination unit 103C determines an analysis method to be applied to the target image based on the output of the language model. The explanatory note used in step S131 and step S132 is the final explanatory note generated by repeating the processing of step S125C to step S127C. Here, in a case where the processing of step S125C to step S127C is omitted, the explanatory note generated in step S124C is used in step S131C and step S132C.

In step S133C, the analysis unit 104C analyzes the target image by applying the analysis method determined in step S132C. In addition, the presentation control unit 108C presents the analysis result of the analysis unit 104C to the user. Thereby, the processing of FIG. 11 is ended.

As described above, the support method according to the present example embodiment includes explanatory note generation processing of causing a generation model to generate an explanatory note of a target image which is obtained by imaging a disaster site, the generation model being obtained by performing machine learning to generate an explanatory note of an image, and analysis method determination processing of determining an analysis method to be applied to the target image, from among a plurality of analysis methods that can be applied to the target image, based on the explanatory note generated by the generation model. Therefore, it is possible to obtain an effect capable of contributing to accurate and rapid disaster response.

### Reference Example 1

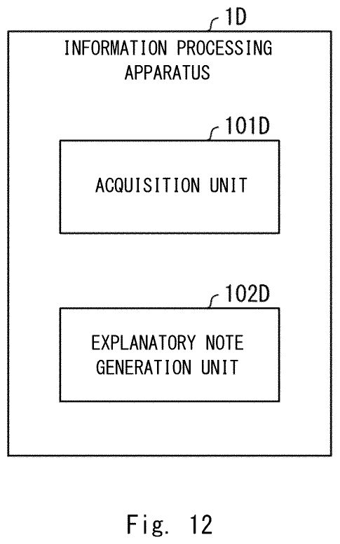

FIG. 12 is a block diagram illustrating a configuration of an information processing apparatus 1D according to the present reference example. As illustrated in FIG. 12, the information processing apparatus 1D includes an acquisition unit 101D and an explanatory note generation unit 102D.

The acquisition unit 101D acquires a target image which is an analysis target, similarly to the acquisition unit 101A of the second example embodiment.

Similar to the explanatory note generation unit 102A in the second example embodiment, the explanatory note generation unit 102D causes a generation model to generate an explanatory note of the target image, the generation model being obtained by performing machine learning to generate an explanatory note of an image. In addition, similar to the explanatory note generation unit 102A in the second example embodiment, the explanatory note generation unit 102D causes the generation model to generate a more detailed explanatory note of the target image by using the explanatory note generated by the generation model.

As described above, the information processing apparatus 1D includes the acquisition unit 101D that acquires a target image which is an analysis target, and the explanatory note generation unit 102D that causes the generation model to generate an explanatory note of the target image, the generation model being obtained by performing machine learning to generate an explanatory note of an image. In addition, the explanatory note generation unit 102D causes the generation model to generate a more detailed explanatory note of the target image by using the explanatory note generated by the generation model. Thereby, it is possible to obtain an effect capable of automatically generating a detailed explanatory note based on the previously-generated explanatory note.

### (Analysis Program)

The above-described functions of the information processing apparatus 1D can also be achieved by a program. The analysis program according to the present example embodiment causes a computer to function as the acquisition unit 101D that acquires a target image which is an analysis target, and the explanatory note generation unit 102D that causes the generation model to generate an explanatory note of the target image, the generation model being obtained by performing machine learning to generate an explanatory note of an image. In addition, the explanatory note generation unit 102D causes the generation model to generate a more detailed explanatory note of the target image by using the explanatory note generated by the generation model. According to the analysis program, it is possible to obtain an effect capable of automatically generating a detailed explanatory note based on the previously-generated explanatory note.

### (Analysis Method)

An analysis method according to the present reference example includes acquisition processing of acquiring, by at least one processor, a target image which is an analysis target, first generating processing of causing a generation model to generate an explanatory note of the target image, the generation model being obtained by performing machine learning to generate an explanatory note of an image, and second generating processing of causing the generation model to generate a more detailed explanatory note of the target image by using the explanatory note generated by the generation model. Therefore, according to the analysis method according to the present example embodiment, it is possible to obtain an effect capable of automatically generating a detailed explanatory note based on the previously-generated explanatory note.

### Reference Example 2

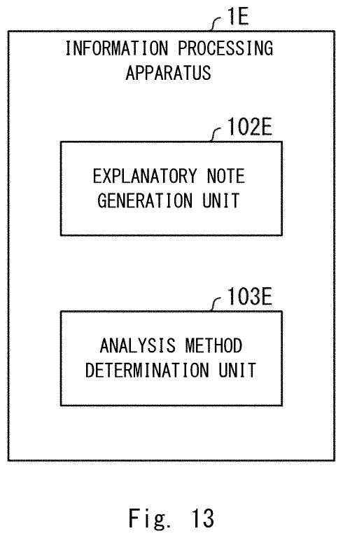

FIG. 13 is a block diagram illustrating a configuration of an information processing apparatus 1E according to the present reference example. As illustrated in FIG. 13, the information processing apparatus 1E includes an explanatory note generation unit 102E and an analysis method determination unit 103E.

Similar to the explanatory note generation unit 102A in the second example embodiment, the explanatory note generation unit 102E causes a generation model to generate an explanatory note of the target image which is an analysis target, the generation model being obtained by performing machine learning to generate an explanatory note of an image.

Similarly to the analysis method determination unit 103A of the second example embodiment, the analysis method determination unit 103E determines an analysis method to be applied to the target image, from among a plurality of analysis methods that can be applied to the target image, based on the explanatory note generated by the generation model.

As described above, the information processing apparatus 1E includes the explanatory note generation unit 102E that causes a generation model to generate an explanatory note of a target image which is an analysis target, the generation model being obtained by performing machine learning to generate an explanatory note of an image, and the analysis method determination unit 103E that determines an analysis method to be applied to the target image, from among a plurality of analysis methods that can be applied to the target image, based on the explanatory note generated by the generation model. Thereby, it is possible to obtain an effect capable of applying an appropriate analysis method according to the content of the target image. In particular, according to the explanatory note generation unit 102E, even in a case where prior information (for example, what kind of object is shown, and the like) related to the target image cannot be obtained, it is possible to generate an explanatory note indicating the content of the target image. Therefore, the information processing apparatus 1E can be suitably applied to analysis of the target image for which prior information cannot be obtained or the target image for which prior information is difficult to obtain.

### (Analysis Support Program)

The above-described functions of the information processing apparatus 1E can also be achieved by a program. An analysis support program according to the present example embodiment causes a computer to function as the explanatory note generation unit 102E that causes a generation model to generate an explanatory note of a target image which is an analysis target, the generation model being obtained by performing machine learning to generate an explanatory note of an image, and the analysis method determination unit 103E that determines an analysis method to be applied to the target image, from among a plurality of analysis methods that can be applied to the target image, based on the explanatory note generated by the generation model. According to the analysis support program, it is possible to obtain an effect capable of applying an appropriate analysis method according to the content of the target image.

### (Analysis Support Method)

An analysis support method according to the present reference example includes causing at least one processor to execute explanatory note generation processing of causing a generation model to generate an explanatory note of a target image which is an analysis target, the generation model being obtained by performing machine learning to generate an explanatory note of an image, and analysis method determination processing of determining an analysis method to be applied to the target image, from among a plurality of analysis methods that can be applied to the target image, based on the explanatory note generated by the generation model. Therefore, according to the analysis support method according to the present example embodiment, it is possible to obtain an effect capable of applying an appropriate analysis method according to the content of the target image.

### [Example of Implementation by Software]

Some or all of the functions of the information processing apparatus 1, 1A, 1D, or 1E, the recording control apparatus 1B, and the support apparatus 1C (hereinafter, also referred to as “each apparatus”) may be implemented by hardware such as an integrated circuit (IC chip) or may be implemented by software.

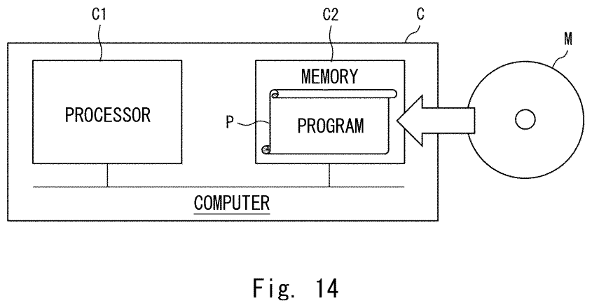

In the latter case, each of the apparatuses is implemented by, for example, a computer that executes a command of a program which is software for implementing each function. An example of such a computer (hereinafter, referred to as a computer C) is illustrated in FIG. 14. FIG. 14 is a block diagram illustrating a hardware configuration of the computer C functioning as each of the apparatuses.

The computer C includes at least one processor C1 and at least one memory C2. A program P for causing the computer C to operate as each of the apparatuses is recorded in the memory C2. In the computer C, the processor C1 reads the program P from the memory C2 and executes the program P to implement each function of each of the apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

Note that the computer C may further include a random access memory (RAM) for developing the program P at the time of execution and temporarily storing various types of data. In addition, the computer C may further include a communication interface for transmitting and receiving data to and from other apparatuses. The computer C may further include an input/output interface for connecting input/output devices such as a keyboard, a mouse, a display, and a printer.

In addition, the program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. In addition, the program P can be transmitted via a transmission medium. As such a transmission medium, for example, a communication network, a broadcast wave, or the like can be used. The computer C can also acquire the program P via such a transmission medium.

In addition, each of the functions of each of the apparatuses may be implemented by a single processor provided in a single computer, may be implemented by cooperation of a plurality of processors provided in a single computer, or may be implemented by cooperation of a plurality of processors provided in a plurality of computers, respectively. In addition, the program for causing each of the apparatuses to implement each of the functions may be stored in a single memory provided in a single computer, may be stored in a distributed manner in a plurality of memories provided in a single computer, or may be stored in a distributed manner in a plurality of memories provided in a plurality of computers, respectively.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### [Supplementary Note]

The present disclosure includes the techniques described in the following supplementary notes. However, the present disclosure is not limited to the techniques described in the following supplementary notes, and various modifications can be made within the scope described in the claims.

### (Supplementary Note A1)

An information processing apparatus including: acquisition means for acquiring a text associated with a target image which is an analysis target; and explanatory note generation means for causing a generation model to generate an explanatory note of the target image according to content of the text, the generation model being obtained by performing machine learning to generate an explanatory note of an image.

### (Supplementary Note A2)

The information processing apparatus according to Supplementary Note A1, in which the explanatory note generation means inputs the acquired text to the generation model, and causes the generation model to generate a more detailed explanatory note of the target image by using the explanatory note generated by the generation model.

### (Supplementary Note A3)

The information processing apparatus according to Supplementary Note A1 or A2, in which the explanatory note generation means repeatedly performs processing of causing the generation model to generate a more detailed explanatory note of the target image until content of the generated explanatory note is no longer improved.

### (Supplementary Note A4)

The information processing apparatus according to any one of Supplementary Notes A1 to A3, further including analysis method determination means for determining an analysis method to be applied to the target image, from among a plurality of analysis methods that can be applied to the target image, based on the explanatory note generated by the generation model.

### (Supplementary Note A5)

An information processing apparatus including: acquisition means for acquiring a target image which is an analysis target; and explanatory note generation means for inputting the acquired target image to a generation model, which is obtained by performing machine learning to generate an explanatory note of an image, and causing the generation model to generate an explanatory note of the target image, in which the explanatory note generation means causes the generation model to generate a more detailed explanatory note of the target image by using the explanatory note generated by the generation model.

### (Supplementary Note A6)

An information processing apparatus including: explanatory note generation means for causing a generation model to generate an explanatory note of a target image which is an analysis target, the generation model being obtained by performing machine learning to generate an explanatory note of an image; and analysis method determination means for determining an analysis method to be applied to the target image, from among a plurality of analysis methods that can be applied to the target image, based on the explanatory note generated by the generation model.

### (Supplementary Note A7)

A verification apparatus including: explanatory note generation means for causing a generation model to generate, according to content of a text associated with content which is a target of truth/falsity determination, an explanatory note of an image included in the content, the generation model being obtained by performing machine learning to generate an explanatory note of an image; and truth/falsity determination means for determining truth/falsity of assertion content of the content based on the explanatory note generated by the generation model.

### (Supplementary Note A8)

A recording control apparatus including: explanatory note generation means for causing a generation model to generate an explanatory note of a target image according to content of a text associated with a target image to be recorded in a database, the generation model being obtained by performing machine learning to generate an explanatory note of an image; and recording control means for recording search information which is for searching for, from the database, the target image and is generated based on the explanatory note generated by the generation model, in association with the target image.

### (Supplementary Note A9)

The recording control apparatus according to Supplementary Note A8, further including classification means for classifying the target image based on the explanatory note, in which the recording control means records a classification result of the classification means in association with the target image.

### (Supplementary Note A10)

A support apparatus including: explanatory note generation means for causing a generation model to generate an explanatory note of a target image which is obtained by imaging a disaster site, the generation model being obtained by performing machine learning to generate an explanatory note of an image; and analysis method determination means for determining an analysis method to be applied to the target image, from among a plurality of analysis methods that can be applied to the target image, based on the explanatory note generated by the generation model.

### (Supplementary Note B1)

An analysis method including: acquisition processing of causing a computer to acquire a text associated with a target image which is an analysis target; and
explanatory note generation processing of causing the computer to input the acquired text to a generation model, which is obtained by performing machine learning to generate an explanatory note of an image, and causing the generation model to generate an explanatory note of the target image according to content of the text.

### (Supplementary Note B2)

The analysis method according to Supplementary Note B1, further including processing of causing, by the computer, the generation model to generate a more detailed explanatory note of the target image by using the explanatory note generated by the generation model.

### (Supplementary Note B3)

The analysis method according to Supplementary Note B1 or B2, in which the at least one processor repeatedly performs processing of causing the generation model to generate a more detailed explanatory note of the target image until content of the generated explanatory note is no longer improved.

### (Supplementary Note B4)

The analysis method according to any one of Supplementary Notes B1 to B3, further including: processing of causing the computer to determine an analysis method to be applied to the target image, from among a plurality of analysis methods that can be applied to the target image, based on the explanatory note generated by the generation model.

### (Supplementary Note B5)

A method including:
acquisition processing of causing a computer to acquire a target image which is an analysis target; and
explanatory note generation processing of causing the computer to input the acquired target image to a generation model, which is obtained by performing machine learning to generate an explanatory note of an image, and causing the generation model to generate an explanatory note of the target image, in which the explanatory note generation processing includes processing of causing the generation model to generate a more detailed explanatory note of the target image by using the explanatory note generated by the generation model.

### (Supplementary Note B6)

A method including:
causing a computer to execute explanatory note generation processing of causing a generation model to generate an explanatory note of a target image which is an analysis target, the generation model being obtained by performing machine learning to generate an explanatory note of an image; and
causing the computer to execute analysis method determination processing of determining an analysis method to be applied to the target image, from among a plurality of analysis methods that can be applied to the target image, based on the explanatory note generated by the generation model.

### (Supplementary Note B7)

A method including:
causing a computer to execute explanatory note generation processing of causing a generation model to generate, according to content of a text associated with content which is a target of truth/falsity determination, an explanatory note of an image included in the content, the generation model being obtained by performing machine learning to generate an explanatory note of an image;
and causing the computer to execute truth/falsity determination processing of determining truth/falsity of assertion content of the content based on the explanatory note generated by the generation model.

### (Supplementary Note B8)

A method including:
causing a computer to execute explanatory note generation processing of causing a generation model to generate an explanatory note of a target image according to content of a text associated with a target image to be recorded in a database, the generation model being obtained by performing machine learning to generate an explanatory note of an image; and
causing the computer to execute recording control processing of recording search information which is for searching for, from the database, the target image and is generated based on the explanatory note generated by the generation model, in association with the target image.

### (Supplementary Note B9)

The method according to Supplementary Note B8, in which
the computer is caused to execute classification processing of classifying the target image based on the explanatory note, and
the recording control processing includes processing of recording a classification result of the classification processing in association with the target image.

### (Supplementary Note B10)

A method including:

causing a computer to execute explanatory note generation processing of causing a generation model to generate an explanatory note of a target image which is obtained by imaging a disaster site, the generation model being obtained by performing machine learning to generate an explanatory note of an image; and causing the computer to execute analysis method determination processing of determining an analysis method to be applied to the target image, from among a plurality of analysis methods that can be applied to the target image, based on the explanatory note generated by the generation model.

### (Supplementary Note C1)

A non-transitory computer-readable recording medium storing an analysis program causing a computer to execute:
acquisition processing of acquiring a text associated with a target image which is an analysis target; and
explanatory note generation processing of inputting the acquired text to a generation model, which is obtained by performing machine learning to generate an explanatory note of an image, and causing the generation model to generate an explanatory note of the target image according to content of the text.

### (Supplementary Note C2)

The non-transitory computer-readable recording medium according to Supplementary Note C1, in which the analysis program causes the computer to execute processing of causing the generation model to generate a more detailed explanatory note of the target image by using the explanatory note generated by the generation model.

### (Supplementary Note C3)

The non-transitory computer-readable recording medium according to Supplementary Note C1 or C2, in which the analysis program causes the computer to repeatedly execute processing of causing the generation model to generate a more detailed explanatory note of the target image until content of the generated explanatory note is no longer improved.

### (Supplementary Note C4)

The non-transitory computer-readable recording medium according to any one of Supplementary Notes C1 to C3, in which the analysis program causes the computer to determine an analysis method to be applied to the target image, from among a plurality of analysis methods that can be applied to the target image, based on the explanatory note generated by the generation model.

### (Supplementary Note C5)

A non-transitory computer-readable recording medium storing a program causing a computer to execute:
acquisition processing of acquiring a target image which is an analysis target; and
explanatory note generation processing of inputting the acquired target image to a generation model, which is obtained by performing machine learning to generate an explanatory note of an image, and causing the generation model to generate an explanatory note of the target image, in which the explanatory note generation processing includes processing of causing the generation model to generate a more detailed explanatory note of the target image by using the explanatory note generated by the generation model.

### (Supplementary Note C6)

A non-transitory computer-readable recording medium storing a program causing a computer to execute:
explanatory note generation processing of causing a generation model to generate an explanatory note of a target image which is an analysis target, the generation model being obtained by performing machine learning to generate an explanatory note of an image; and
analysis method determination processing of determining an analysis method to be applied to the target image, from among a plurality of analysis methods that can be applied to the target image, based on the explanatory note generated by the generation model.

### (Supplementary Note C7)

A non-transitory computer-readable recording medium storing a program causing a computer to execute:
explanatory note generation processing of causing a generation model to generate, according to content of a text associated with content which is a target of truth/falsity determination, an explanatory note of an image included in the content, the generation model being obtained by performing machine learning to generate an explanatory note of an image; and
truth/falsity determination processing of determining truth/falsity of assertion content of the content based on the explanatory note generated by the generation model.

### (Supplementary Note C8)

A non-transitory computer-readable recording medium storing a program causing a computer to execute:
explanatory note generation processing of causing a generation model to generate an explanatory note of a target image according to content of a text associated with a target image to be recorded in a database, the generation model being obtained by performing machine learning to generate an explanatory note of an image; and
recording control processing of recording search information which is for searching for, from the database, the target image and is generated based on the explanatory note generated by the generation model, in association with the target image.

### (Supplementary Note C9)

The non-transitory computer-readable recording medium according to Supplementary Note C8, in which at least one processor is caused to execute classification processing of classifying the target image based on the explanatory note, and the recording control processing includes processing of recording a classification result of the classification processing in association with the target image.

### (Supplementary Note C10)

A non-transitory computer-readable recording medium storing a program causing a computer to execute:
explanatory note generation processing of causing a generation model to generate an explanatory note of a target image which is obtained by imaging a disaster site, the generation model being obtained by performing machine learning to generate an explanatory note of an image; and
analysis method determination processing of determining an analysis method to be applied to the target image, from among a plurality of analysis methods that can be applied to the target image, based on the explanatory note generated by the generation model.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor executing the instructions to:
acquire a text associated with a target image which is an analysis target; and
input the acquired text to a generation model, which is obtained by performing machine learning to generate an explanatory note of an image, and cause the generation model to generate an explanatory note of the target image according to content of the text.

2. The information processing apparatus according to claim 1, wherein the at least one processor causes the generation model to generate a more detailed explanatory note of the target image by using the explanatory note generated by the generation model.

3. The information processing apparatus according to claim 1, wherein the at least one processor repeatedly performs processing of causing the generation model to generate a more detailed explanatory note of the target image until content of the generated explanatory note is no longer improved.

4. The information processing apparatus according to claim 1, wherein the at least one processor determines an analysis method to be applied to the target image, from among a plurality of analysis methods that can be applied to the target image, based on the explanatory note generated by the generation model.

5. An analysis method comprising:
acquisition processing of causing a computer to acquire a text associated with a target image which is an analysis target; and
explanatory note generation processing of causing the computer to input the acquired text to a generation model, which is obtained by performing machine learning to generate an explanatory note of an image, and causing the generation model to generate an explanatory note of the target image according to content of the text.

6. The analysis method according to claim 5, further comprising processing of causing, by the computer, the generation model to generate a more detailed explanatory note of the target image by using the explanatory note generated by the generation model.

7. The analysis method according to claim 5, wherein the computer repeatedly performs processing of causing the generation model to generate a more detailed explanatory note of the target image until content of the generated explanatory note is no longer improved.

8. The analysis method according to claim 5, further comprising:
processing of causing the computer to determine an analysis method to be applied to the target image, from among a plurality of analysis methods that can be applied to the target image, based on the explanatory note generated by the generation model.

9. A non-transitory computer-readable recording medium storing an analysis program causing at least one processor of a computer to execute:
acquisition processing of acquiring a text associated with a target image which is an analysis target; and
explanatory note generation processing of inputting the acquired text to a generation model, which is obtained by performing machine learning to generate an explanatory note of an image, and causing the generation model to generate an explanatory note of the target image according to content of the text.

10. The non-transitory computer-readable recording medium according to claim 9, wherein the analysis program causes the computer to execute processing of causing the generation model to generate a more detailed explanatory note of the target image by using the explanatory note generated by the generation model.

11. The non-transitory computer-readable recording medium according to claim 9, wherein the analysis program causes the computer to repeatedly execute processing of causing the generation model to generate a more detailed explanatory note of the target image until content of the generated explanatory note is no longer improved.

12. The non-transitory computer-readable recording medium according to claim 9, wherein the analysis program causes the computer to determine an analysis method to be applied to the target image, from among a plurality of analysis methods that can be applied to the target image, based on the explanatory note generated by the generation model.
